(19) United States
(12) Patent Application Publication
(10) Pub. No.: US 2005/0015180 A1
(43) Pub. Date: Jan. 20, 2005

(54) Station with control panel

(76) Inventor: Peter Steger, Bad Worishofen (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/718,655

(22) Filed: Nov. 24, 2003

(30) Foreign Application Priority Data
Nov. 25, 2002 (DE) 102 55 056.5

(51) Int. Cl. G06F 7/00

(52) U.S. Cl. 700/230

(57) ABSTRACT

The invention refers to a station, in particular machining, measuring, conveying station and the like which is in particular arranged in a machining or production line, with at least one control device with control panel for indication, control and/or diagnosis functions of the station. The invention is characterised by the fact that the control panel is connected portably and wireless with at least one station, respectively control device of the station, and/or a central control unit of the machining or production line.

### BACKGROUND OF THE INVENTION

The invention refers to a station, in particular machining, measuring, conveying station or the like which is arranged in particular in a machining or production line, with at least one control device with control panel for indication, control and diagnosis functions of the station, the control panel being able to act portably and wireless at least on the control device of the station.

Machining, measuring, conveying stations and the like in machining or production lines are known. These are stations which are arranged along a production line or a machining line (for example transfer lines) and which machine, measure, mount or convey workpieces which are in the machining or production line in order to be machined. According to the state of the art each station, respectively machine, has a firmly mounted main operating part from which all machine functions can be activated, viewed, diagnosed, respectively controlled. In addition to that control panels with a reduced range of functions are arranged where often operating actions have to be carried out. This may, for example, be necessary at the loading place of the tool magazine or also at the set-up place for the workpieces.

Also portable manual operating apparatus are known which are connected by means of cables with the main operating panel, respectively with the main control table, of a station. Manual operating apparatus of this kind are used when for certain jobs a position has to be taken from which the main control table, respectively the main operating panel, cannot be reached. This is, for example, necessary when the service person has to be inside the working room of a station in order to carry out set-ups procedures.

According to the state of the art it is now necessary that the operating and control functions have to be carried out by persons who move along the production line and monitor, respectively activate, the necessary machine functions on the respective main control panels of the stations.

In interlinked systems also the controls of the periphery have individual control panels. Peripheral interlinked devices of this kind are, for example, robots, test stations, mounting stations or washing machines. These also have their own control panels. As along a machining or production line very different stations by very different manufacturers may be arranged the service person(s) of a machining or production line must command very different operating surfaces of the different machines.

For safety reasons certain control functions can only be accessed by certain service persons who have, for example, special qualifications for this kind of activities. These functions then can, for example, only be called if certain passwords are entered, respectively if one has keys for corresponding key-operated switches. The keys have to be available for the right persons at the right moment. This means higher expenses when a machine is acquired. The problem of the passwords is that it is difficult to keep them a secret from unauthorised persons. Manual operating apparatus which are connected via a cable with the control devices of the station are, because of the impeding cables, very uncomfortable to operate. Additionally the cables can be damaged comparatively quickly. Furthermore there is a risk of accidents because the service persons can tip over the cables.

The same problems also exist in machining centers with one or more, if necessary portable, control panels. Here also the above-described problems occur analogously.

The European patent specification 369 188 describes a communication, information and maintenance, diagnosis and training system where a data network is provided in which also production machines may be arranged and manually carried control panels can be connected via a chain of infrared satellites with the network. Here, in addition to the wire network, also a wireless network basing on infrared lines is provided, which is comparatively expensive. Therefore such an arrangement can in particular be used in fields where a wire network cannot be installed. In addition to that such a system is only intended for diagnosis or maintenance operation.

The German specification 196 25 997 describes an optical transmission line for the quick adjustment, respectively regulation, of the respective elements of a machine.

In the same way as the European patent specification 369 188 the wireless transmission is carried out in the optical frequency field, for example in the infrared range, however, this needs a direct visual contact between transmitter and receiver. The use of such an arrangement for control functions is in no way secure with such arrangements.

### BRIEF SUMMARY OF THE INVENTION

Coming from this state of the art it is the object of this invention to design this described prior art in a safer way.

In order to solve this problem the invention proposes first of all that, coming from the station as described in the beginning, a locally binding device is provided and an acting of the portable control panel on the control device, respectively on the station, is only possible when the locally binding device is activated. The safety degree of the station according to the invention is considerably improved by means of this suggestion according to the invention. Because it is provided, according to the invention, that the station can be controlled through the portable control panel, by means of the suggestion according to the invention it is secured that such a control possibility is only possible when the locally binding device is activated. By means of that it is avoided securely that a service person who has a distance too large from the station which has to be controlled controls it and, perhaps, causes hazardous machining steps of the station without being able to control or monitor them directly.

Eventually the locally binding device provides that it is secured that the service person, respectively the portable control panel which controls the station, has a corresponding distance from the station.

The locally binding device here causes a “band” independently from the communication between the control panel and the station, which only has the use to make sure that the service person is in a, if necessary, predefined distance from the station and thus can use, on the one hand, the advantages of the wireless control panel, however, on the other hand, is not so far away from that that unintended machining steps or functions of the station are carried out without control.

In the same way, however, this problem is also solved by a station according to the invention where the wireless connection between the control panel and the control device occurs by radio, in particular in a frequency range between 200 megahertz and 100 gigahertz, preferably between 1 and 10 gigahertz, in particular between 2 and 3 gigahertz as well as between 4 and 6 gigahertz.

In the state of the art wireless connections between the control panel and the station only with the help of optical transmission lines, for example in the infrared range, are known. This arrangement requires that there always must be a free visual contact between the transmitter and the receiver. When this free visual contact between transmitter and receiver is interrupted unintended, for example by an open machine cabinet door or the like, eventually the control is interrupted and the machine, respectively the station, cannot be mastered anymore through the control panel. The logical consequence from that is that uncontrolled machine, respectively station, conditions can result and that the safety is lowered considerably.

By means of the suggestion according to the invention the operating safety and therefore also the safety of the station on the other hand is improved considerably. The use of a radio band in a frequency range between 200 megahertz and 100 gigahertz allows operating the station with the help of a wireless connected control panel very reliably. In particular with the frequency band between 1 and 10 gigahertz excellent operation results have been reached because the connection in particular in this frequency range is surprisingly very little prone to interference and stable. It has to taken into consideration here that the invention in particular can be used for metal cutting or other machining devices like electrical discharge machining and so on where a considerable electromagnetic soiling threatens which, of course, threatens also to influence the communication channel. However, actually these influences are small and that becomes possible, on the one hand, by means of the selected frequency band and, on the other hand, can be influenced favourably by the corresponding transmission protocol of the communication channel working in this frequency band. However, for the time being it is achieved to suggest in this preferred frequency intervals between 1 and 10 gigahertz and even more in the part bands of 2 and 3 gigahertz as well as 4 to 6 gigahertz a frequency range that basically can be used well. In this connection in particular the technology known as “Bluetooth” has to be mentioned where a communication protocol extremely stable against interference between the transmitter and the receiver is used.

According to the invention it is provided here that the two uniform measurements described above each solve individually already the task according to the invention. For each of that the invention seeks protection. It is, of course, possible that these two measurements are coupled together and thus a considerable improvement of the operational safety is achieved. On the one hand the service staff is forced by that to stay in a pre-definable distance from the station when it is being controlled, and, on the other hand, the communication between the control panel and the station is effective, reliable and safe.

It is not important here that the locally binding device is designed as an independent system. According to the invention the locally binding device can be realised very variably, namely that, on the one hand, the locally binding device is realised in an individual module or system or, in another variant, the connection which exists anyway because of the communication channel is evaluated in that respect that by means of it a locally binding device is realised.

It is, for example, possible, as it is also provided in a variant of the invention, to activate the locally binding device only by the fact the signal emitted by the control panel is received by the receiver at minimum signal intensity. When this minimum signal intensity is fallen short of the control panel may by in a too large distance from the receiver and therefore maybe out of the range of the station which has to be controlled. When this minimum signal intensity is fallen short of for example for a longer period of time (the limit here may be selected freely) the locally binding device is deactivated and at least the control possibility of the station via the control panel after that is switched off. If necessary it is, however, still possible to carry out corresponding indication and diagnosis functions by means of the control panel.

Conveniently here the service person will transfer in a certain interval above the minimum signal intensity corresponding information in order to indicate the imminent discontinuation of the control authorisation. Simultaneously here also the station can be moved into a corresponding uncritical position in order to secure the station itself.

The locally binding device has to be understood in that respect also as a function which has a corresponding functionality and which is in the result activated or deactivated, as a consequence of which then the station can be commanded, in particular, be controlled or not by the control panel. Such a procedure can in particular easily be integrated in the course of the process.

With station according to the invention, which is suited in particular for machining, measuring, mounting or conveying jobs and is arranged either in a machining or production line or in a machining center, it is achieved that by means of a control panel all functions of the station, respectively the stations, can be called, respectively controlled. Simultaneously it is possible that the station, respectively the central control unit, communicates with the control panel, respectively via the control panel with the user. Because of the control panel the control panels which have been arranged until now at each station separately are not necessary anymore. Only a control device of the station is needed which is connected with the control panel as well as, if necessary, with the central control unit of the machining, respectively production, line or the machining center. Therefore all fixedly installed control desks, respectively also the key-operated switches or codification devices which have been arranged at the respective control desks are not necessary anymore. Furthermore impeding cables of the so far known portable control panels which have been linked via cables with the respective stations are dropped. Thus also the risk of accidents in machining, respectively production, lines decreases.

Of course it is also possible that a control panel is connected only with one single station. Of course it is also provided that a control panel can only connect with one central control unit of the machining and production line. Additional costs for the purchase of the machines, respectively purchase of the control desks, respectively codification and security devices are dropped as well, respectively are reduced considerably as they now can, on the one hand, be designed uniformly for a complete production line or machining center, and it has only to be made sure that the control panel can connect with the station or stations as well as with a central unit, which can be arranged if necessary.

According to a convenient further embodiment of the invention it is provided that the station, respectively the central control unit, is connected by at least one transmitter each and one receiver each and the control panel by a transmitter/receiver unit to each other. By means of this it is guaranteed that a data exchange (or a communication) is possible between the station, central control unit and control panel without any problems bidirectionally.

According to a convenient further development of the solution according to the invention at least one control panel can be connected with several stations simultaneously or one after the other. Here the control panel can optionally simultaneously also be connected with the central control unit of the machining or production line, respectively of the machining center. By means of the advantageous development it is achieved to reduce further the effort for the plant engineering. By means of the suggestion according to the invention it is achieved that for example two stations one arranged behind the other can be controlled and commanded via one control panel. In a smart way here an indication device of the control panel is separated accordingly for both stations and thus the different functions are shown simultaneously. Therefore the invention allows realising also comparatively complex control jobs in an elegant way. It is naturally possible also to control and monitor several stations at the same time with the control panel, in this respect the invention is not limited in its field of application.

In a preferred embodiment of the invention it is provided that the control panel acts indirectly via the central control unit or directly on the control device of the station.

According to the invention there are several possibilities how the control panel can act on the control device. Depending on the design of the station, respectively its integration in the machining and production line it is convenient here that the control panel acts via the central control device on the station or its control device. However, when there is already a corresponding logic (for example a control) provided in the station, the invention can also here be used advantageously as the data traffic in the data network may be reduced accordingly if the control panel acts directly on the control device of the station. If necessary such a communication is provided when in the central control unit the corresponding entitlements and authorisations have been called.

Another aspect of the station according to the invention is given by uniform function, indication and control programmes of the control panels and stations, respectively their control devices, in such a way that a uniform operating of the different stations, independently from the respective machine type, is possible. By means of this variant the control and programme effort for a machining or production line, respectively a machining center, can be successfully reduced considerably. The respective machine types, respectively their controls, are programmed each to the then uniform function, indication, control programmes.

According to the invention it was also found to be an advantage when the control panel is connected wireless with the central control unit of the machining and production line in such a way that from the control panel programmes and functions of the central control unit for the machining and production line, respectively for a special station, can be called and/or activated, respectively transmitted to the control panel. By means of that the effort for the control panels themselves is reduced because it is not necessary there to back up certain programmes which are already available in the central control unit of the machining and production line. It has only to be taken into consideration that the control panels can communicate with the central control unit.

The further development of the station according to the invention is characterised by the fact that the station has a definite station codification and, because of this station codification, in the control panel the respective programmes and functions can be activated. By means of this variant of the invention it becomes possible that certain control panels are only available for certain programmes and functions each, respectively their carrying out, respectively for a special station the respective corresponding programmes, functions and/or data are made available. The respective control programmes here are fed in another variant because of the station codification by the central control unit or by the station in the control panel (virtually “in-time”) by means of which the control panel has always the actual programme version at its disposal.

It has also proved to be an advantage when the control panel has a definite control panel codification. It is, for example, backed up in the central control unit which user is with which control panel at the production line in order to call, for example, when corresponding errors messages are given, exactly the respective user (depending from his authorised activities, training respectively responsibilities) via his control panel and to call corresponding maintenance or installation procedures. The control panel codification proposed according to the invention allows here a definite and also reliable link with the respective user.

The station according to the invention is characterised by a wireless connection. This connection can be an electromagnetic connection, for example a radio connection, infrared or optical connection. In order to realise a wireless connection here several technical possibilities are possible. In particular a radio connection is especially suited for the realisation of the solutions according to the invention. If necessary, also solutions by means of infrared, respectively optical connections, are possible. The advantages of the use of a radio band in the range of 200 megahertz until 100 gigahertz has already pointed out in detail above.

It has also proved to be an advantage that, via the control panel by means of an identifying device, the user of it can be assigned certain programmes, respectively functions. Identifying devices of this kind are, for example, key-operated switches, password checks via input, respectively field of view, magnetic strip reader, smart card, transponder worn on the body, respectively finger print identifying or measurement of the iris of the eye. By means of such a further development of the station it is achieved that the authorised operations of the respective user can be assigned to the respective control panel.

It is, for example, provided here that, if certain employees do not have a sufficient qualification for certain jobs, only jobs and functions are assigned which can be carried out by the employees. These may be, for example, installation jobs, respectively tool changing jobs. It is, for example, possible that certain control panels are only codified for the service person who on the set-up place, respectively the loading place, for the workpieces put these on the production line, respectively in the feeding conveying devices provided for that. The operational security of the total production line, respectively of a machining center, is increased considerably by that.

A further development of the station according to the invention is characterised by the fact that the control panel has voice select menus by means of which different voices can be set. This guarantees that, for example, also foreign employees of a firm, who work simultaneously at a machining or production line, can communicate without any problems with the stations as well as with the central control unit as well as with each other. Of course it is also possible to provide these voice selection menus for shipments of the installations abroad. The corresponding voice modules, respectively programmes, can here, for example be called by the central control unit, respectively result from a corresponding information (data field) which is checked during the identification.

According to a variant of the invention it is provided that the locally binding device is designed as additional wireless connection between the control panel and the station, respectively the machining or production line. As already described above the locally binding device is not limited to be an independent additional module, but it is possible that the locally binding device monitors accordingly also already existing communication channels between the control panel and the station and in the result of this monitoring the locally binding device is either active or inactive. In this variant it is provided that the locally binding device is designed as additional wireless connection. It is for example, provided that an additional communication basing on radio or optical transmission line is established. However, the term connection is not limited to that. It is also possible to reach this additional wireless connection for example by means of locating, the locating being carried out, of course, also wireless. It is also provided that this connection is filtered out, for example, in the frame of the exchanged information necessary for control.

In this connection it is an advantage when the locally binding device is realised in an arrangement separated from the control panel, in particular in a person identification apparatus, and the locally binding device can only be activated when the service person carrying this arrangement is in the range of the station. For example, corresponding transponders are already known as suitable person identification apparatus. A corresponding reader is placed in the range of the station and, for example, the access to the station is designed in such a way that the service person has to pass this reader and therefore the locally binding device is activated. As a last consequence also by means of that an additional wireless connection is realised.

Another very efficient alternative design of the invention is given by the fact that the locally binding device is carried out by a locating arrangement for the continuous definition of the location either of the control panel or the service person and the locally binding device can only be activated when the location is within the range of the station. For that also several variants are possible. In a first variant, for example, a receiver of a global positioning system (GPS) is provided in the control panel or in the arrangement carried by the service person. By means of that an identification of the location either of the control panel or the service person is carried out. This location is transmitted as co-ordinate by the control panel or the arrangement either to the central control unit or to the control device. Here then the adjustment of the location with the range of the station is carried out. The range of the station is presented there as the plane described by co-ordinates within which an operating of the respective station should be allowed. If this location is within the range of the station, the locally binding device is activated and a control of the station is possible. If this location is outside the range of the station the locally binding device is deactivated, an influence, in particular a control, of the control panel on the respective station is not possible.

Alternatively, however, it is also possible that the locating arrangement is reached by a position finding. In this case several directional receivers are located in the range of the station and the radio wave emitted by the control element or the arrangement is located accordingly. By means of triangulation also here the respective location can be identified and the adjustment, as described above, can be carried out.

In addition to these wireless connections as locally binding device it is also possible to design the locally binding device as electromagnetic, mechanic or optical switch. For this purpose, for example, sensors which register movement, barriers, photoelectric barriers, light barriers, turnstiles and the like are available which can be operated accordingly and thus guarantee that the service person is within the range of the station.

It is convenient here that the locally binding device can only be activated within a predefined distance from the station. This distance can be defined and set in many ways. On the one hand it is, for example, possible to set it via the transmitting power of the control panels. If the person goes away too far from the station and its receiver, the signal received there accordingly falls below the minimum signal intensity and the control connection is interrupted. For a locating the respective distance is defined by means of the plane predefined as co-ordinates.

In a preferred variant of the invention it is provided that the locally binding device is designed as a connection operating in the radio band or in the infrared spectral range. As described the locally binding device can use the already existing connections or it can have or establish a separate, independent connection. Possibly the combination here with a system operating on visual range, that is for example in the range of the infrared spectrum, is not convenient. For a safe data transfer conveniently the radio line is used. As infrared spectral range here is seen the spectral range between about 800 nanometer and 1 mm wave length.

Preferably the locally binding device in another variant is activated by the fact that the signal emitted by the control panel is received by several, if necessary, predefined receivers. By means of that it is possible to assign the service person within the station a certain movement, the control panel then being identified by several receivers. These receivers then can accordingly be selected in order to control, respectively limit, the possibilities of movement of the service person.

According to an advantageous development of the station according to the invention it is provided that the control panel is designed as a control panel unit worn on the head. This control panel unit takes over control, indication and input jobs. The control panel unit can here, for example by means of a headband, be fastened to the head of the service person. Of course it is also provided to design the control panel unit in the shape of a helmet as it is, for example, known from the motor racing sport or from the military aviation.

According to the invention the control panel unit may have here a visor through which information for the service person is indicated.

It is also an advantage here when the control panel, in particular the control panel unit, has a voice input and output system through which the communication between service person and control panel is carried out.

It has also been found to be an advantage when the control panel has sensors for the activity of the service person which react to irregularities of the service person and, if necessary, activate an emergency programme. It is therefore, for example, provided that the sensors react to irregularities like overtiredness, sudden sleep, accidents, calls for help or the like. When, for example, the service person has an accident in a station, via sensors of this kind then the complete station, respectively the production or machining line can be stopped in order to protect the person. An advantage are these embodiments described above in particular because, by means of a control panel unit worn on the head, the service person altogether gets further freedom of movement. For example both hands are free for other manual operations. Simultaneously an eye protection can be realised by means of such a control panel unit as it is enforced in many firms, because of worker's protection rules, in particular in the US. Simultaneously by means of that also the identification of the service person can be guaranteed in every moment. This may be carried out for example, as already described, by iris diagnosis and the like.

The reaction of the system, respectively the control panel itself, on certain inadmissibilities of the service person increases the operational security and the comfort of the operating altogether. For example sensors in the visor should recognise when the person is unconscious for a short time or when, for example, the service person is overtired. A sensor of this kind could also react to working accidents and, if necessary, stop the machine, the station, respectively the complete installation and quickly call for help. Here optical systems are preferred. However, other systems are also suited to solve the tasks at hand.

A further development of the station according to the invention is characterised by the fact that the control panel has a touch-sensitive screen for control, indication, input, respectively operating, functions. Screens of this kind are extremely comfortable and are already available in very different sizes. It is an advantage here when this touch-sensitive screen is underlaid, respectively supplemented, by a digitalizer. Modern control panels designed like that can be equipped in the way of a portal, which can be carried on a belt around the neck, respectively over the shoulder. However, they may also be designed, as described above, as headband, helmet and the like.

Another aspect of the station according to the invention is given by the fact that the station itself, when error messages occur, respectively jobs have to be carried out, if necessary depending from the kind of error, respectively job, transmits an error information, respectively a job information, to a special control panel, depending from the recognised error, respectively the recognised job, to a special control panel. By means of that for example the service person qualified for the solution of the impending job can be informed and called immediately. It is, for example, also provided that via a central control unit the person, respectively the control panel, is selected which is situated nearest to the respective station which has emitted the error message, respectively the job message, and therefore also the maintenance is optimised.

It has also been found that it is an advantage when the control panel has an information unit which is activated by the arrival of error information, respectively job information, and thus informs accordingly the service person. Information units of this kind may be acoustical, optical and/or mechanical information units. Of course, also a combination of the above described information indication possibilities is possible.

An advantageous further development of the station according to the invention is characterised by a digitalised data transfer of the wireless connection. By means of that the advantages of a digitalised data transfer are used also for the station, for the control panels, respectively the central control unit.

It is also found that it is an advantage when the central control unit, respectively the station or the control panel protocols and, if necessary, stores the programmes, respectively functions, carried out at the station each via the control panel. By means of that it is provided that later certain carried out operations, respectively controls or other activities related to the functions, can be reconstructed. Information of this kind is also important for the analysis of the interference behaviour of certain installation parts which may lead to the elimination of recognised bottlenecks.

In a preferred embodiment of the invention it is provided that the control panel has, on the one hand, an information indication and information input device. The control panel, for example, is designed as a board equipped, for example, with a keyboard and, if necessary, with a mouse control which also has a screen for indicating the respective control information and so on. For manipulation, if necessary, also a control element, similar to a joystick, is provided. The complete control panel is here realised in such a way that it is designed quite solid on the one hand and, on the other hand, can be carried without any problems, for example can be put on.

The object of the invention is also solved by a machine line with at least one station as it is described before in the very different embodiments. As machine line here counts, in the sense of the invention, in particular machining or production lines. As far as in the following machining or production lines are mentioned synonymously also machine lines have to be understood by that. By means of the machining and production line with a station according to the invention with a portable control panel which can communicate with the station(s) as well as with the central control unit or also with several control panels it is guaranteed that the machining and production lines, respectively the machining centers can do with considerable less expenses for control and operating devices. Furthermore such a production or machining line is characterised by the fact that the susceptance to faults through operational errors of the service staff are reduced altogether.

According to a convenient further development of the production or machining line it is provided that several stations are connected via a common transmitter and receiver with at least one control panel and/or the central control unit. This may be a simultaneous connection as well as a connection which has to be established one after the other.

Another aspect of the production and machining line is given by the fact that the central control unit is designed as central computer. By means of that the programmes, respectively the functions, which are available are increased altogether which improves the versatility of such a production, respectively machining, line altogether. Therefore it is possible to create in a machining or production line, respectively in a production center, a central information and operating system through which all installations, respectively machine parts, the central computer, respectively the central control unit, the control panels, respectively via the control panels the corresponding service persons can be reached and, if necessary can exchange among each other information and instructions. A system of this kind can be, for example, installed in a production hall. The data security when the data are exchanged can be reached here by means of corresponding data secure connections, as it can, for example, be reached via digitalised radio connections or also via transfer of information by means of energy supply systems, as for example electro cables.

In another advantageous embodiment of the invention it is provided that the stations of the machining and production line as well as the central control unit are connected to each other via a data network and the transmitter/receiver, respectively the locally binding device, is connected either indirectly over the station or directly with the data network. By means of this data network it is possible, on the one hand, to monitor and co-ordinate the flow of workpieces through the stations of the machining line. On the other hand, however, it is also possible by means of this data network to direct the corresponding instructions from the control panel to the respective control or via transmitters and receivers in the network to the respective station or directly to the station.

The object according to the invention is solved also through the use of a portable control panel in a machining or production line which is connected wireless with at least one station and/or the central control unit of the machining and/or production line, respectively the machining center. All advantages already described above also occur through the use of a portable control panel in a machining or production line.

Furthermore the object of the invention is solved by a method for the establishing a communication for indication, control and/or diagnosis purposes between a control panel and a station, in particular according to one or more of the solutions described above. Here first of all a communication channel is established between the control panel and the station, at least the station codification is transferred into the control panel and, because of the station codification, then the respective programmes, respectively functions, for the station can be operated, respectively called, on the control panel.

A further development of this method is characterised by the fact that the control panel receives the respective programmes, respectively functions, depending from the station codification on the central control unit, respectively the central computer. Of course, it is also possible to call, because of the mutual communication between the control panel, station and central computer, the respective programme functions from the central computer.

A further development of the method according to the invention is characterised by the fact that the user is identified via an identifying device at the control panel and user-dependent the respective programmes, respectively functions, are made available. A method has also proved convenient which is characterised by the fact that one control panel is connected simultaneously with two or more stations, respectively with the central computer, respectively the central control unit.

Furthermore the method is characterised by the fact that one station is connected with two or more control panels and, if necessary, with the central control unit simultaneously.

According to a variant of the method according to the invention it is suggested that simultaneously, before or after the establishment of the communication channel, the locally binding device is checked and, if the check has been positive, the locally binding device is activated. The locally binding device has to be checked comparatively soon after the beginning of the communication as the operation of the station, in particular a control of the station, should only be possible when the locally binding device is active. If necessary it is alternatively provided that, when the locally binding device is not yet active, only maintenance, diagnosis and situation information is transferred, but an influence on the machine itself in the sense of a control is not possible.

In the frame of the invention it is also provided that during the check of the locally binding device it is checked whether the control panel transmits another signal serving the locally binding device and the receiver receives it. When such a signal, if necessary, with sufficient field strength is received the locally binding device is activated and a control of the station is possible.

In the same way it is checked, during the check of the locally binding device, whether a switch, which is, if necessary, equipped arbitrarily and is located in the range of the station, has been operated by the service person. When this switch is operated the locally binding device is activated.

In a preferred embodiment of the invention it is proposed furthermore that, before the control panel can access the station for indication, control and/or diagnosis purposes, the identity of the service person, which has been defined by the identifying device, is checked in the central control unit and, because of the check, programmes, functions, authorisations, respectively fields of jobs intended for the service person are released and after this release the control panel in the frame of the release mentioned above accesses the station directly. By means of this procedure according to the invention it is achieved that two advantages are realised. First of all it is possible to administrate in the central control unit centrally in a corresponding data bank the service staff and to release for the service staff certain rights of programmes, functions, authorisations, respectively responsibilities, by means of which the corresponding control of the respective very different stations is available. The advantage here is that this data care is carried out centrally. However, after that it is not resorted to the central control unit anymore, but the control panel accesses then in the frame of the release mentioned above directly the station. By means of that the control is accelerated considerably as the data network is not impeded with the data transfer. A safe and also reliable and fast operation results.

The invention presents the following advantages. By means of the use of portable control panels which each can be assigned to a person fixedly or can be assigned because of an identification, and which can connect, respectively communicate, with the machining and conveying modules, respectively the individual installation parts, respectively stations and the central control unit of the machining and production line, all fixedly installed control desks and the individual stations, respectively installation parts, are not necessary anymore. Furthermore the corresponding safety devices, like key-operated switches and codification devices, which had to be realised so far on fixedly installed control desks, can be left out.

The control panels can be configured for each person individually in respect of voice, picture and range of functions. In the range of functions it can be determined which modules and stations, respectively installation parts, a person is authorised to operate and which functions there a person is authorised to use. Furthermore, of course, certain functions for which the service person is not qualified, can correspondingly be excluded and locked. That means that the assignment can be done with respect to the jobs and qualifications selectively for selected machines. The key-operated switches and passwords for the individual stations are not necessary here. Furthermore it is possible to limit the number of users for operating functions which are even usually not protected. All diagnosis functions for the machine units, for the stations, for the central, for the conveying and for transfer media are at the continuous disposal of the user within the range of the wireless connections. The service person does not even have to be directly at the respective station for that purpose in order to get information for example about pre-alarms, shortage of parts, error messages or the like.

For example it may be provided that the machine, respectively the station, calls, if necessary independently, the suitable staff. Another advantage is given by the fact that, independently from the type of machine and manufacturer of the controls, uniform user interfaces are provided altogether for the control panels. By means of that a present cause of interference is removed. The fact that the control desks are portable makes them highly ergonomic. It is, for example, also possible to assign certain jobs which have been so far carried out by several service persons, to a single service person.

### BRIEF DESCRIPTION OF THE DIFFERENT VIEWS OF THE DRAWINGS

In the following the invention is described more detailed by means of embodiments and figures. In the figures:

FIG. 1: a machining and production line with stations designed according to the invention;

FIG. 2: a block diagram of the way of function of the data transfer between the stations of the central control unit and the control panel.

### DETAILED DESCRIPTION OF THE PREFERRED EMBODIMENT

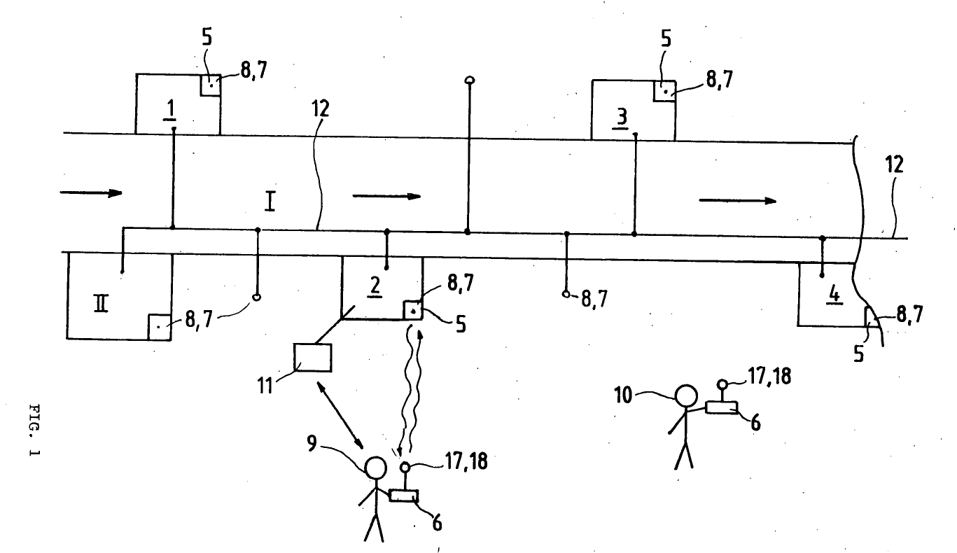

FIG. 1 shows schematically a machining or production line I where on both sides the stations 1-4 are arranged. At the starting point of the machining line, respectively the production line I, the central control unit II is arranged. Along the machining line, respectively production line I, several service persons move who are only shown diagrammatically. In this embodiment only two service persons have been selected. Of course, considerably more service persons may be present at the machining and production line. This depends in particular from the size of the respective installation.

As machining and production lines of this kind have a size which fills whole factory halls it is, of course, possible that a multitude of stations and a multitude of service persons are present along these machining and production lines. The service persons 9 and 10 carry portable control panels 6. Here the control panels 6 are equipped, for example, with transmitters 17 and receivers 18 which can connect wireless with the stations 1-4 as well as with the central control unit II. The service persons 9 and 10 can move here freely and are not linked with the control desks which are usually fixedly arranged at the stations 1 to 4. Neither are they linked via a cable with the individual stations, respectively with the central control unit II, but they can, for example, communicate via radio connections with all installation parts, for example for maintenance and diagnosis purposes and with the central control unit II. The stations 1-4, as well as the central control unit II are connected to each other via a data network 12. In this data network 12 as well as in the stations 1-4 transmitters and receivers 7, 8 are provided. The transmitting/receiving unit 17, 18 of the control panel 6 can here access either via the transmitter/receiver 7, 8 of the respective stations 1-4 or directly the ones of the data network 12. The comfort of such an arrangement is increased considerably as for example for diagnosis purposes (not for control purposes) an access to the data network 12 and the connected units is possible from any place.

FIG. 1 explains that the stations 1-4 as well as the central control unit II have also transmitter 7 and receiver 8. At, the respective stations here additionally a control device of the station 5 is arranged. All advantageous embodiments of the invention already described above can be carried out by means of a solution chosen that way. In the schematic diagram according to FIG. 1 only the connection between the station II and the service person 2 via the control panel 6 is indicated. As already described before several stations and/or the central control unit may be connected simultaneously. Furthermore a locally binding device 11 is provided which co-operates with the station II. The locally binding device is activated only when the person 9 is within the range of the station 2. For that purpose several means have been described. When the locally binding device 11 has been activated the station II is released at least for control applications of the user 9.

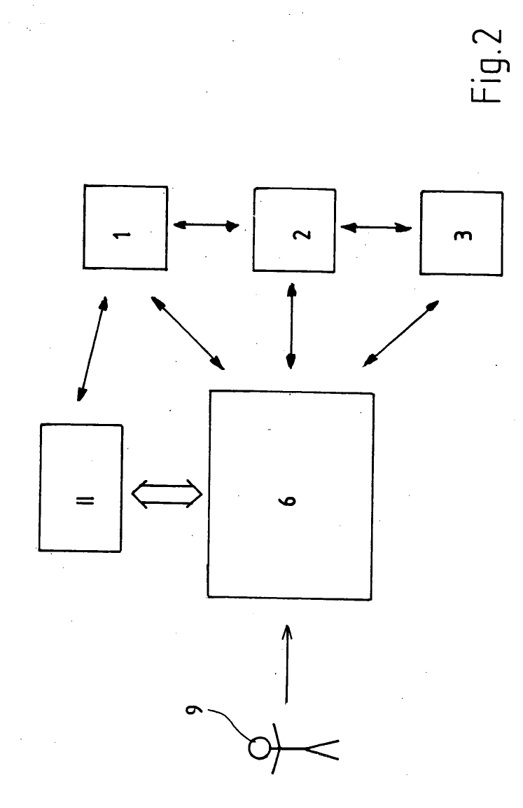

FIG. 2 shows a block diagram which makes clear how the communication of the individual parts of the invention is carried out. After, for example, the service person 9 has been registered, respectively identified, by the control panel 6, the service person can now call via the central control unit the functions of this control unit which have been assigned to him. Simultaneously he can call via the control panel 6 the individual stations 1, 2 or 3 either simultaneously or one after the other and operate the functions assigned to him. The communication between the respective stations can, of course, be carried out in such a way that a transmitter and a receiver is arranged only at the station 1 and the stations 1, 2 and 3 are linked to each other so that the exchange of information, respectively data, between the individual stations 1-4, the control panel 6 and the central control unit II is carried out only via the transmitter and the receiver of the station 1. An exchange of data between the respective stations and the central control unit II independently from the control panel 6 is, of course, also possible.

Although the invention has been described by exact examples which are illustrated in the most extensive detail, it is pointed out that this serves only for illustration and that the invention is not necessarily limited to it because alternative embodiments and methods become clear for experts in view of the disclosure. Accordingly changes are considered which can be made without departing from the contents of the described invention.

1. Station, in particular machining, measuring, conveying station and the like which is arranged in particular in a machine line with a central control unit, with at least one control unit with a control panel for indication, control and/or diagnosis functions of the station, the control panel (6) being able to act portably and wireless at least upon the control device (5) of the station, characterised in that a locally binding device is provided and the portable control panel (6) can act upon the control device (5), respectively the station (1-4), only when the locally binding device is activated.

2. Station according to claim 1, characterised in that the station (1-4), respectively the central control device (II), and the control panel (6) are connected to each other by at least one transmitter (7) each and at least one receiver (8) each, and that the control panel (6) has a transmitter/receiver unit (17, 18) for a bidirectional communication with the station (1-4), respectively the central control unit (II).

3. Station according to claim 1, characterised in that at least one control panel (6) can be connected with several stations (1-4) simultaneously or one after the other.

4. Station according to claim 1, characterized in that the control panel (6) acts indirectly over the central control unit (II) or directly on the control device (5) of the station (1-4).

5. Station according to claim 1, characterised by uniform function, indication and control programmes of the control panels (6) for the stations (1-4), respectively their control devices (5), in such a way that a uniform operation of the different stations is possible independently from the respective type of machine.

6. Station according to claim 1, characterised in that the control panel (6) is connected wireless with the central control unit (II) of the machining and production line (I) in such a way that programmes and functions of the central control unit (II) from the control panel (6) for the machining and production line (I), respectively for a particular station, can be called and/or activated, respectively can be transmitted to the control panel.

7. Station according to claim 1, characterised in that the station (1-4) has a definite station codification and because of the station codification in the control panel (6) the respective programmes and functions for the station can be activated.

8. Station according to claim 1, characterised in that the control panel (6) has a definite control panel codification.

9. Station according to claim 1, characterised in that certain programmes, functions, authorisations, respectively areas of responsibilities, can be allocated to the service person through the control panel (6) via an identifying device, for example a key-operated switch, password check via input and view panel, magnetic strip reader, smart card, transponder or the like.

10. Station according to claim 1, characterised in that the wireless connection is an electromagnetic connection, for example a radio link, an infrared or optical connection.

11. Station according to claim 1, characterized in that the control panel (6) has voice select menus by means of which voices can be set.

12. Station according to claim 1, characterised in that the locally binding device is designed as additional wireless connection between the control panel and the station, respectively the machining and production line.

13. Station according to claim 1, characterised in that the locally binding device is realised in an arrangement which is separated from the control panel, in particular from the person identifying apparatus, and the locally binding device can only be activated when the service person carrying this arrangement is within the range of the station.

14. Station according to claim 1, characterised in that the locally binding device is formed by means of a locating arrangement for the continuous identification of the location either of the control panel or the service person, and the locally binding device can only be activated when the location is in the range of the station.

15. Station according to claim 1, characterised in that the locally binding device is designed as electromagnetic, mechanic, electric or optically acting switch.

16. Station according to claim 1, characterised in that the locally binding device can only be activated within a pre-defined distance between the service person and the station.

17. Station according to claim 1, characterised in that the locally binding device is designed as connection operating in the radio band or in the IR spectral range.

18. Station according to claim 1, characterised in that the locally binding device can be activated by receiving the signal emitted by the control panel through the receiver with minimum signal intensity.

19. Station according to claim 1, characterised in that the locally binding device can be activated by receiving the signal emitted by the control panel through several, if necessary pre-defined, receivers.

20. Station according to claim 1, characterised in that the control panel (6) is designed as a control panel unit which is worn on the head and has in particular a goggle-like form.

21. Station according to claim 1, characterised in that the control panel (6) is designed as a control panel unit worn on the head and that it has a visor by means of which information for the service person (9, 10) is indicated.

22. Station according to claim 1, characterised in that the control panel (6) has a voice input and output system, through which the communication between the service person (9, 10) and the control panel (6) is carried out.

23. Station according to claim 1, characterised in that the control panel (6) has sensors for the activity of the service person which recognise irregularities of the service person (9, 10) and, if necessary, activate an emergency programme, in particular activate a stopping of the station or the production line.

24. Station according to claim 1, characterised in that the control panel (6) has a data input and a data indication device, in particular a touch-sensitive screen for control, indication, input, respectively service, functions.

25. Station according to claim 1, characterised in that the stations (1-4) on occurring error messages, respectively pending jobs, if necessary depending from the kind of error, respectively job, transmit error information, respectively job information, to a control panel (6), depending from the kind of error, respectively job, to a special control panel (6).

26. Station according to claim 1, characterised in that the control panel (6) has an acoustically, optically and/or mechanically acting information unit which is activated by the arrival of an error or job information.

27. Station according to claim 1, characterised by a digitalized data transfer of the wireless connection.

28. Station according to claim 1, characterised in that the central control unit (II), respectively the station (1-4) or the control panel (6) also protocols and, if necessary, stores the individual programmes/functions carried out on the station via the control panel (6).

29. Station according to claim 1, characterized in that the wireless connection between the control panel (6) and the control unit (5) is carried out via radio, in particular in a frequency range between 200 megahertz and 100 gigahertz, preferably between 1 and 10 gigahertz, in particular between 2 and 3 gigahertz, as well as between 4 and 6 gigahertz.

30. Station in particular machining, measurement, conveying station and the like which in particular is arranged in a machine line with at least one control unit with control panel for indication, control and/or diagnosis functions of the station, the control panel (6) being able to act, portably and wireless, at least upon the control device (5) of the station, characterized in that the wireless connection between the control panel (6) and the control device (5) is carried out via radio, in particular in a frequency range between 200 megahertz and 100 gigahertz, preferably between 1 and 10 gigahertz, in particular between 2 and 3 gigahertz, as well as 4 and 6 gigahertz.

31. Machine line with at least one station (1-4), in particular machining, measurement, conveying station and the like, with at least one control device with control panel for indication, control and/or diagnosis functions of the station as well as a central control unit of the machine line, the control panel (6) being able to act, portably and wireless, at least upon the control device (5) of the station, characterised in that a locally binding device is provided and an influence of the portable control panel (6) on the control device (5), respectively the station (1-4) is possible only when the locally binding device is activated.

32. Machine line according to claim 31, characterised in that several stations (1-4) are connected via a common transmitter (7) and receiver (8) with at least one control panel (6) and/or the central control unit (II).

33. Machine line according to claim 31, characterised in that the central control unit (II) is designed as central computer.

34. Machine line according to claim 31, characterised in that the stations (1-4) of the machining, respectively production, line as well as the central control unit (II) are connected to each other by a data network and the transmitter/receiver (7, 8), respectively the locally binding device, is either indirectly connected via the station or directly with the data network.

35. Machine line according to claim 31, characterised in that the machine line is designed as machining line, respectively as production line.

36. Method for establishing a communication for indication, control, and/or diagnosis purposes between a control panel and a station, in particular machining, measurement or conveying station, a plurality of stations being arranged in a machine line and the stations being connected by a data network to each other and with a central control unit of the machine line, at first a communication channel being established between the control panel and the station, at least the station codification being transmitted into the control panel and, because of the station codification the respective programmes, respectively the functions, for the station becoming able to be operated on the control panel.

37. Method according to claim 36, characterised in that the station can only be operated when the locally binding device is activated.

38. Method according to claim 36, characterised in that simultaneously, before or after establishing the communication channel the locally binding device is checked and, if the checking is positive, the locally binding device is activated.

39. Method according to claim 36, characterised in that with the locally binding device it is checked whether a further signal serving the locally binding device has been sent from the control panel and is received by the receiver.

40. Method according to claim 36, characterised in that with the locally binding device it is checked whether switches located in the range of the station are operated by the service person.

41. Method according to claim 36, characterized in that the control panel depending on the station codification is fed with the respective programmes/functions from the central control unit (II).

42. Method according to claim 36, characterized in that the service person is identified via an identifying device on the control panel and is, user-dependent, supplied with the respective programmes/functions.

43. Method according to claim 36, characterised in that one control panel is connected simultaneously with two or more stations.

44. Method according to claim 36, characterised in that one station is connected simultaneously with two or more control panels.

45. Method according to claim 36, characterised in that before the control panel can access the station for indication, control and/or diagnosis purposes, the identity of the service person who has been determined by the identifying device is checked in the central control unit and because of this checking programmes, functions, authorisations, respectively areas of responsibility intended for the service person are cleared and after this clearing the control panel accesses the station in the frame of the above mentioned clearing directly.
